(19) United States
(12) Patent Application Publication
(10) Pub. No.: US 2021/0363362 A1
(43) Pub. Date: Nov. 25, 2021

(54) METHOD FOR DEPOSITING AN ORGANIC INTUMESCENT COATING ON A GLASS SHEET

(71) Applicant: SAINT-GOBAIN GLASS FRANCE, Courbevoie (FR)

(72) Inventors: Marine BRUNET, PARIS (FR); François COMPOINT, PARIS (FR); François POTIER, PARIS (FR); Samuel KRON, NOIRMOUTIER EN L'ILE (FR)

(21) Appl. No.: 16/968,008

(22) PCT Filed: Feb. 14, 2019
(86) PCT No.: PCT/FR2019/050331

§ 371 Date: Aug. 6, 2020

(30) Foreign Application Priority Data
Feb. 16, 2018 (FR) 1851336
Mar. 23, 2018 (FR) 1852540

(51) Int. Cl. C09D 5/18; C03C 17/32; C03C 17/00; C09K 21/12; C09D 131/04; C09D 133/08

(52) U.S. Cl. CPC C09D 5/185; C03C 17/32; C03C 17/007; C08K 5/092; C09D 131/04; C09D 133/08; C09K 21/12

(57) ABSTRACT

A method for the deposition of an organic intumescent coating on a glass sheet, includes the preparation of an organic intumescent coating composition by mixing a latex having a pH from 4 to 6 and an intumescent agent chosen from thermally degradable polycarboxylic acids, and the application of the organic intumescent coating composition to the glass sheet.

The present invention relates to the field of fire-resistant glazing. It especially relates to a method for the deposition of an organic intumescent coating on a glass sheet, and also to a glazing unit comprising a glass sheet coating with an organic intumescent coating able to be obtained by this process.

Fire-resistant glazing is conventionally formed of a highly viscous aqueous solution based on hydrated alkali metal silicates sealed between two glass sheets (EP 3023245, WO 2007/118886, WO 2007/053248, EP 2072247, EP 2282889, WO 2008/053248). Other fire-resistant glazing is formed of a layer of solid hydrogel between two glass sheets, obtained by crosslinking a solution of water-soluble monomers (US 2016/2000077, EP 2330174). In the former case, the fire protection is provided by the opaque mineral foam formed by the expansion of the layer of silicates due to the evaporation of the water contained therein under the effect of heat. For the layer of hydrogel, unlike the layer of alkali metal silicate, there is no foam formation. The propagation of fire is slowed by the evaporation of the water and the inorganic additives contained in the layer of hydrogel. While these solutions are effective, they employ manufacturing processes which may prove complex due to restrictions related to the injection of a solution between two glass sheets.

Organic intumescent coatings exist, such as paints or varnishes, developed to improve the fire resistance of construction materials. Such coatings comprise a polymeric binder and an intumescent system generally formed of an acid source such as phosphoric acid or an ammonium polyphosphate, of a carbon-based compound such as a polyol, and a blowing agent such as urea or melamine. When they are exposed to fire, these coatings foam up and produce a carbonaceous protective residue. The carbonaceous residue acts as a barrier, physically and thermally protecting the coated material. In the majority of cases, the coating also has an esthetic role, making it possible to modify the appearance of the surfaces of the covered materials. “Transparent” intumescent varnishes also exist, and are intended for applications to surfaces made of wood or plastic, making it possible to retain the esthetic appearance of the covered surfaces.

This type of intumescent coating is of benefit for improving the fire resistance of glazing. However, the “transparent” intumescent varnishes known to date are not entirely satisfactory. When they are applied in a thick layer to glass, they have a milky appearance which is unacceptable from an esthetic perspective. Indeed, it would appear that these coatings actually need to be applied to a sufficiently porous or rough surface in order to be perceived as transparent after application.

The aim of the present invention is to propose an organic intumescent coating which simultaneously is suited to application to a glass sheet, does not affect the optical properties of said sheet, and has good intumescence.

Thus, a first aspect of the present invention relates to a process for the deposition of an organic intumescent coating on a glass sheet, comprising:
preparation of an organic intumescent coating composition by mixing a latex and an intumescent agent; and
application of the organic intumescent coating composition to the glass sheet; characterized in that the latex has a pH from 4 to 6 and the intumescent agent is chosen from thermally degradable polycarboxylic acids, preferably citric acid. Indeed, the applicant has demonstrated that the use of a latex having a pH from 4 to 6 in combination with a thermally degradable polycarboxylic acid, especially citric acid, as intumescent agent made it possible to provide good processability, especially for the deposition of thick layers (for example of the order of a millimeter or more), and to obtain a coating having high transparency and low haze, while having good intumescent properties.

The latex is an aqueous dispersion of an organic binder. The organic binder is preferably a thermoplastic polymer. Examples of organic binders comprise homopolymers or copolymers derived from vinyl comonomers or monomers. Vinyl monomers comprise especially the α-alkenes such as ethylene, propylene or isoprene, vinyl chloride, vinylidene chloride, styrene, vinyltoluene, acrylonitrile and vinyl esters. Examples of vinyl esters comprise especially C1-C12 vinyl carboxylates such as vinyl acetate, vinyl propionate, vinyl butyrate, vinyl isobutyrate, vinyl valerate, vinyl hexanoate, vinyl 2-methylhexanoate, vinyl 2-ethylhexanoate, vinyl isooctanoate, vinyl nonanoate, vinyl decanoate, vinyl laurate, vinyl palmitate, vinyl stearate, vinyl neodecanoate and C9-C11 vinyl versatates (also referred to as VeoVa for vinyl ester of versatic acid). Preferred organic binders comprise copolymers based on α-alkenes, especially ethylene, and on one or more esters of vinyl and/or vinyl chloride, such as ethylene/vinyl acetate copolymers, ethylene/vinyl acetate/vinyl chloride terpolymers and ethylene/vinyl acetate/vinyl ester, especially C9-C11 vinyl versatate, terpolymers.

The latex has a pH from 4 to 6, preferably from 4.5 to 5.5, making it possible in particular to provide homogeneous dispersion of the thermally degradable polycarboxylic acid in the coating composition, while retaining good processability.

The thermally degradable polycarboxylic acid is a compound comprising at least two carboxylic acid functions which degrades and releases a gaseous compound under the effect of the rise in temperature (for example greater than 100° C., or even 150° C.), which enables the expansion of the organic coating. The thermally degradable polycarboxylic acid preferably has a solubility in water at 20° C. of greater than 50 g/l. The thermally degradable polycarboxylic acid may be a dicarboxylic acid such as oxalic acid, malonic acid, malic acid, tartaric acid, tartronic acid or maleic acid, a tricarboxylic acid such as citric acid or tricarballylic acid or a tetracarboxylic acid such as 1,2,3,4-butanetetracarboxylic acid. The choice of a thermally degradable polycarboxylic acid, especially citric acid, as intumescent agent, is advantageous since, while providing good intumescence, it does not affect, or only very slight affects, the total light transmission of the coating formed and does not induce any, or very much, haze.

The coating composition typically has a solids content of 30 to 70%, preferably 40 to 60%, by weight. It typically comprises from 5 to 50%, preferably from 10 to 40%, or even from 15 to 30% by dry weight of intumescent agent.

The coating composition may also comprise fillers, especially inorganic or organometallic fillers, such as particles of silica (especially colloidal silica), silicates, sol-gel metal oxide precursors or coupling agents based on silanes. The fillers are advantageously chosen so as not to affect the optical properties of the coating. To this end, fillers chosen from sol-gel metal oxide precursors, especially of silicon and/or of titanium, are preferred. It may comprise from 0.5% or even 1% to 60%, or even 50%, 40%, 20% or even 15% by weight of fillers. Contents of lower than 5% or even 2% by dry weight are however preferable in order to limit the appearance of haze. Preferably, the coating composition does not comprise fillers.

The coating composition may also comprise from 0.5 to 15%, preferably 1 to 10% by dry weight of a flame retardant. The flame retardant is preferably chosen from organophosphorus compounds, especially phosphonates such as diethyl ethylphosphonate or dimethyl methylphosphonate.

The glass sheet may have a thickness which varies from 1 to 8 mm, preferably 2 to 6 mm. The glass may be a soda-lime-silica glass obtained by floating on a bath of tin (according to the “float” process), a borosilicate glass or any other type of transparent glass. It may be clear or colored glass depending on the desired esthetic finish. In a first alternative, the glass sheet is an untempered glass sheet. In a second alternative, it is a tempered glass sheet.

The coating composition may be applied to the surface of the glass sheet by any technique known to those skilled in the art, for instance wet deposition techniques such as spray coating, curtain coating, flow coating, roller coating or by pouring. It may optionally be applied several times in order to obtained the desired final coating thickness. After application, the deposit is dried, typically at temperature from 20 to 80° C. for 5 minutes to 24 hours, preferably for 5 to 20 minutes, in order to obtain an organic intumescent coating.

Another aspect of the present invention relates to a glazing unit comprising a glass sheet coated with an organic intumescent coating, especially able to be obtained by the process described above, characterized in that the organic coating comprises an organic binder and an intumescent agent, said intumescent agent being chosen from thermally degradable polycarboxylic acids, preferably citric acid.

The characteristics of the coating composition described above relating to the nature of the components and the amounts thereof also apply to the organic intumescent coating.

The organic intumescent coating typically has a thickness from 0.01 to 3 mm, preferably from 0.05 to 2 mm. It typically has a total light transmission of greater than 85%, preferably greater than 87%, and a haze of less than 15%, preferably less than 10%, measured with a hazemeter according to standard ASTM D1003-00 with illuminant C.

The organic intumescent coating may be in direct contact with the glass sheet. For the purposes of the present invention, an element A “in direct contact” with an element B means that there is no other element arranged between said elements A and B. On the other hand, an element A “in contact” with an element B does not exclude the presence of another element between said elements A and B. Alternatively, a connecting layer, especially based on silanes, may be arranged between the organic intumescent coating and the glass sheet in order to improve the adhesion thereof to the glass sheet.

The organic intumescent coating has the property of foaming under the effect of temperature, typically at temperatures greater than 100° C., or even greater than 180° C., for example between 200 and 400° C., to reach at least eight times, preferably at least ten times, their initial thickness.

The glazing unit may be single glazing or multiple glazing (for example double or triple). It may comprise several organic intumescent coatings. In the case of single glazing, for example, the glass sheet may be coated with an organic intumescent coating on each of its faces. In the case of multiple glazing, several glass sheets, or even each glass sheet, may be coated on at least one of their faces with an organic intumescent coating. The glazing unit may also comprise functional coatings, especially solar control, low-e, photocatalytic, etc. In a particular embodiment, the glazing unit according to the invention is a fire-resistant glazing unit comprising two glass sheets separated by an organic intumescent coating according to the invention or a stack of layers comprising the organic intumescent coating according to the invention, this fire-resistant glazing unit also possibly being incorporated into a multiple glazing optionally comprising functional coatings.

The invention is illustrated with the help of the following nonlimiting examples.

### EXAMPLES

The compositions of examples 1 (according to the invention) and 2 to 6 (comparative) were prepared by mixing various latices and 20% by weight of intumescent agents. These compositions were subsequently deposited by pouring onto the surface of a glass sheet 2.5 mm in thickness, then dried to obtain an organic intumescent coating of approximately 2 mm. The total light transmission (TL) and the haze of the coatings were measured with a hazemeter according to standard ASTM D1003-00 with illuminant C.

The coated glass sheets were subsequently subjected to temperatures of 300° C. for 10 minutes. The intumescence quality of the organic coating during this heat treatment was quantified by comparison of the thickness of the foam obtained relative to the initial thickness of the intumescent coating.

Unlike the previous examples, the compositions of examples 7 to 9 were not prepared from latex but from a crosslinkable resin based on acrylates (polyester acrylate and polyethylene glycol (PEG 400) acrylate—10:90 ratio by weight). The resin is mixed with a photoinitiator, then the intumescent agents (20% by dry weight) are introduced into the mixture. The formulation is subsequently deposited on a substrate and crosslinked under UV lamp.

Table 1 below summarizes the nature of the coating compositions and the properties of the intumescent coatings obtained. The processability, taking into account the ease of processing of the composition and the quality of the coating obtained, is graded as follows: ⊗ application impossible; [symbol] application possible but poor quality coating; ◯ application possible and good quality coating.

TABLE 1

| Ex. | Binder | pH | Intumescent agent | Processability | T_{L} | Haze | Intumescence |
|---|---|---|---|---|---|---|---|
| 1 | Vinyl acetate/ | 4.5-5.5 | Citric acid | ◯ | >87% | <10% | >800% |
| | ethylene/vinyl ester | | | | | | |
| | terpolymer | | | | | | |
| 2 | Vinyl acetate/ | 4.5-5.5 | Sorbitol + urea + | ◯ | <87% | >10% | <800% |
| | ethylene/vinyl ester | | phosphoric acid | | | | |
| | terpolymer | | | | | | |
| 3 | Vinyl acetate/ | 4.5-5.5 | Ammonium | ◯ | <87% | >10% | >800% |
| | ethylene/vinyl ester | | polyphosphate + | | | | |
| | terpolymer | | melamine + | | | | |
| | | | pentaerythritol | | | | |
| 4 | Vinyl acetate/ | 7-9 | Citric acid | ⊗ | n.m. | n.m. | n.m. |
| | ethylene/acrylate | | | | | | |
| | terpolymer | | | | | | |
| 5 | Acrylic ester/ | 7.5-8.5 | Citric acid | ⊗ | n.m. | n.m. | n.m. |
| | ethylene/vinyl ester | | | | | | |
| | terpolymer | | | | | | |
| 6 | Acrylic ester/ | 7-8.5 | Citric acid | ⊗ | n.m. | n.m. | n.m. |
| | methacrylic ester | | | | | | |
| | copolymer | | | | | | |
| 7 | Acrylate resin | — | Citric acid | [symbol] | n.m. | n.m. | n.m. |
| 8 | Acrylate resin | — | Sorbitol + urea + | [symbol] | n.m. | n.m. | n.m. |
| | | | phosphoric acid | | | | |
| 9 | Acrylate resin | — | Ammonium | [symbol] | n.m. | n.m. | n.m. |
| | | | polyphosphate + | | | | |
| | | | melamine + | | | | |
| | | | pentaerythritol | | | | |

n.m.: not measurable

Only the composition of example 1 has good processability and makes it possible to obtain a coating having both satisfactory optical and intumescent properties. On the other hand, the coating compositions of examples 2 and 3 do not make it possible to obtain a coating having adequate haze and/or intumescence for an application on glass. The compositions of examples 4 to 9 do not have adequate processability: for examples 4 to 6, the composition gels quickly, preventing any application; for examples 7 to 9, the coating obtained cracks and/or delaminates following drying and crosslinking.

1. A process for the deposition of an organic intumescent coating on a glass sheet, comprising:
preparing an organic intumescent coating composition by mixing a latex and an intumescent agent; and
applying the organic intumescent coating composition to the glass sheet; wherein the latex has a pH from 4 to 6 and the intumescent agent is chosen from thermally degradable polycarboxylic acids.

2. The process as claimed in claim 1, wherein the latex is an aqueous dispersion of a polymeric organic binder derived from vinyl monomers chosen from α-alkenes, vinyl chloride, vinylidene chloride, styrene, vinyltoluene, acrylonitrile and vinyl esters.

3. The process as claimed in claim 2, wherein the organic binder is a copolymer based on α-alkene and on one or more esters of vinyl and/or vinyl chloride.

4. The process as claimed in claim 1, wherein the intumescent agent is chosen from oxalic acid, malonic acid, malic acid, tartaric acid, tartronic acid, maleic acid, citric acid, tricarballylic acid and 1,2,3,4-butanetetracarboxylic acid.

5. The process as claimed in claim 1, wherein the intumescent agent is citric acid.

6. The process as claimed in claim 1, wherein the coating composition comprises 5 to 50% by dry weight of intumescent agent.

7. The process as claimed in claim 1, wherein the coating composition comprises 0.5 to 15% by dry weight of a flame retardant.

8. The process as claimed in claim 7, wherein the flame retardant is an organophosphorus compound.

9. A glazing unit comprising a glass sheet coated with an organic intumescent coating, obtainable by the process as claimed in claim 1, wherein the organic coating comprises an organic binder and an intumescent agent, said intumescent agent being chosen from thermally degradable polycarboxylic acids.

10. The glazing unit as claimed in claim 9, wherein said coating has a total light transmission of greater than 85%.

11. The glazing unit as claimed in claim 9, wherein said coating has a haze of less than 15%.

12. The glazing unit as claimed in claim 9, wherein the organic binder is a homopolymer or copolymer derived from vinyl monomers chosen from α-alkenes, vinyl chloride, vinylidene chloride, styrene, vinyltoluene, acrylonitrile and vinyl esters.

13. The glazing unit as claimed in claim 9, wherein the intumescent agent is chosen from oxalic acid, malonic acid, malic acid, tartaric acid, tartronic acid, maleic acid, citric acid, tricarballylic acid and 1,2,3,4-butanetetracarboxylic acid.

14. The glazing unit as claimed in claim 9, wherein the intumescent agent is citric acid.

15. The process as claimed in claim 2, wherein the α-alkenes include ethylene, propylene or isoprene.

16. The glazing unit as claimed in claim 12, wherein the α-alkenes include ethylene, propylene or isoprene.
